(19) United States
(12) Patent Application Publication
(10) Pub. No.: US 2025/0094858 A1
(43) Pub. Date: Mar. 20, 2025

(54) SYSTEMS AND METHODS FOR APPLICATION MONITORING

(71) Applicant: Capital One Services, LLC, McLean, VA (US)

(72) Inventors: Abel Fletcher, Aubrey, TX (US); Sekhar Prasad Gurrapu, Wilmington, DE (US); Bhaskar Banerjee, Plano, TX (US); Kevin P. Poffenberger, Townsend, DE (US)

(21) Appl. No.: 18/467,108

(22) Filed: Sep. 14, 2023

(51) Int. Cl. G06N 20/00; G06F 40/20

(52) U.S. Cl. CPC G06N 20/00; G06F 40/20

(57) ABSTRACT

Disclosed embodiments may include a system for monitoring applications. The system may receive first data associated with a first application. Responsive to receiving the first data, the system may retrieve second data associated with the first application. The system may generate third data associated with the first application by analyzing the second data via natural language processing (NLP). The system may train a machine learning model (MLM) to determine a first threshold associated with the first application based on the third data. The system may transmit the first threshold to a user. Responsive to transmitting the first threshold, the system may receive fourth data associated with a second application. The system may determine, via the MLM and based on the fourth data, an updated first threshold associated with the second application.

### FIELD

The disclosed technology relates to systems and methods for application monitoring. Specifically, this disclosed technology relates to determining a threshold associated with an application monitor or alert, and changing or updating the threshold based on user-specific application data.

### BACKGROUND

In a heavily cloud-based marketplace, businesses and entities typically rely on a variety of online applications and platforms. Many of these applications and platforms can be generic or common across any business or entity regardless of business purpose. For example, most if not all cloud-based operations rely on hard drives, load balancers, and other types of similar infrastructure.

Accordingly, there is a need for improved systems and methods for application monitoring. Embodiments of the present disclosure may be directed to this and other considerations.

### SUMMARY

Disclosed embodiments may include a system for application monitoring. The system may include one or more processors, and memory in communication with the one or more processors and storing instructions that, when executed by the one or more processors, are configured to cause the system to monitor applications. The system may receive first data associated with a first application. Responsive to receiving the first data, the system may retrieve second data associated with the first application. The system may generate third data associated with the first application by analyzing the second data via natural language processing (NLP). The system may train a machine learning model (MLM) to determine a first threshold associated with the first application based on the third data. The system may transmit the first threshold to a user. Responsive to transmitting the first threshold, the system may receive fourth data associated with a second application. The system may determine, via the MLM and based on the fourth data, an updated first threshold associated with the second application.

Disclosed embodiments may include a system for application monitoring. The system may include one or more processors, and memory in communication with the one or more processors and storing instructions that, when executed by the one or more processors, are configured to cause the system to monitor applications. The system may transmit a first threshold to a user, the first threshold associated with a first application. The system may iteratively until a first response is received: receive data associated with a second application; determine, via an MLM and based on the data, an updated first threshold associated with the second application; and transmit a notification to the user, the notification requesting the user provide the first response based on the updated first threshold. Response to receiving the first response, the system may maintain the updated first threshold associated with the second application.

Disclosed embodiments may include a system for application monitoring. The system may include one or more processors, and memory in communication with the one or more processors and storing instructions that, when executed by the one or more processors, are configured to cause the system to monitor applications. The system may receive first data associated with a first application, the first data corresponding to a failure of the first application. The system may train an MLM to determine a first threshold associated with the first application based on the first data. The system may retrieve second data associated with the first application, the second data corresponding to a time period prior to a start time of the failure. The system may determine, via the MLM and based on the second data, an updated first threshold associated with the first application.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for application monitoring in accordance with certain embodiments of the disclosed technology.

FIG. 2 is a flow diagram illustrating an exemplary method for application monitoring in accordance with certain embodiments of the disclosed technology.

FIG. 3 is block diagram of an example threshold generation system used to monitor applications, according to an example implementation of the disclosed technology.

FIG. 4 is block diagram of an example system that may be used to monitor applications, according to an example implementation of the disclosed technology.

### DETAILED DESCRIPTION

As cloud-based entities and organizations may utilize similar online infrastructure, there may be opportunity for these entities and organizations to learn from one another as to the technical challenges associated with individual components of this online infrastructure, such as applications and programs. For example, certain organizations may find these infrastructure components operate more successfully, or that they fail, if run under certain conditions. Organizations may thus find it helpful to identify attributes of infrastructure components or applications, and establish respective monitors or alerts for these applications. Once these monitors or alerts are established, thresholds for when and/or how to transfer these monitors or alerts to system users may be determined and continuously updated.

Accordingly, examples of the present disclosure may provide for receiving data associated with a first application, determining a threshold associated with the first application, transmitting the threshold to a user (e.g., an organization), receiving user-specific data, and updating or customizing the threshold based on the user-specific data such that the updated threshold may be applied to a second application owned and/or operated by the user.

Disclosed embodiments may employ machine learning models (MLMs), among other computerized techniques, to determine a first threshold associated with a first application, and to update the first threshold based on user-specific data such that the updated threshold may be applied to a second application. Machine learning models are a unique computer technology that involves training models to complete tasks and make decisions. These techniques may help to improve database and network operations. For example, the systems and methods described herein may utilize, in some instances, MLMs, which are necessarily rooted in computers and technology, to evaluate data corresponding to a user to determine how an application threshold may be updated and applied to a user-specific application. This, in some examples, may involve using user-specific application input data and an MLM, applied to determine an updated threshold for applying to a certain application. Using an MLM and a computer system configured in this way may allow the system to provide a customized threshold for monitoring a user's application.

This may provide an advantage and improvement over prior technologies that may provide individualized monitoring of applications on a user-by-user basis, which can cause significant technical challenges and upsets within cloud-based infrastructure. The present disclosure solves this problem by determining an initial monitor or alert associated with an application, determining a threshold associated with that monitor or alert, and updating or customizing the threshold based on user-specific application data. Furthermore, examples of the present disclosure may also improve the speed with which computers can determine application monitoring alerts and thresholds. Overall, the systems and methods disclosed have significant practical applications in the cloud-based infrastructure monitoring field because of the noteworthy improvements of the determination of initial alerts and updated application thresholds, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

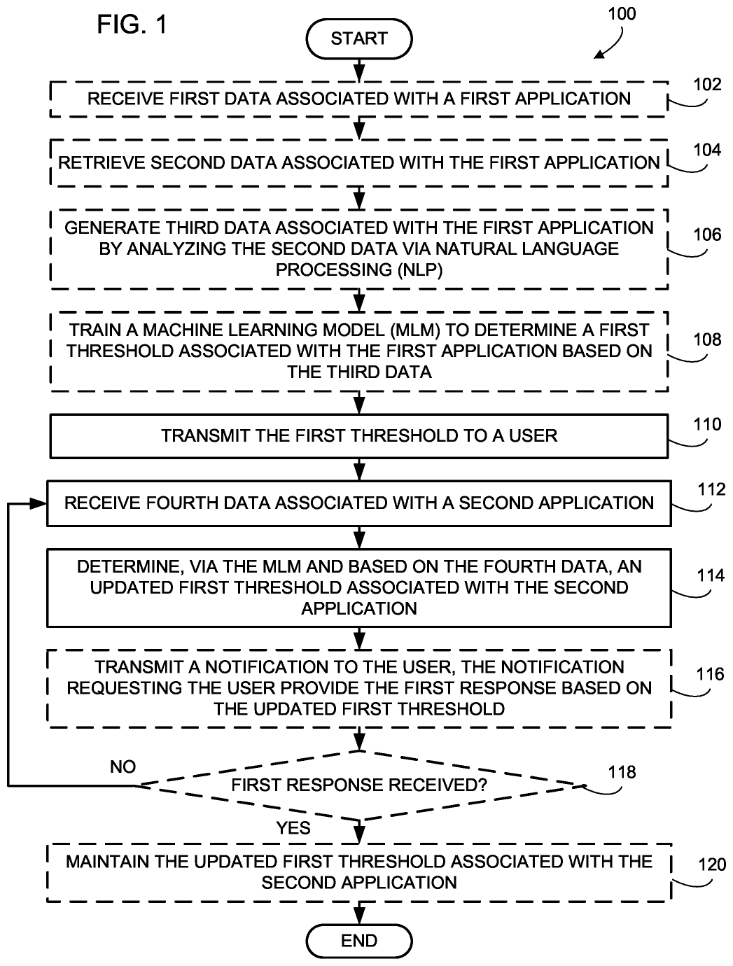

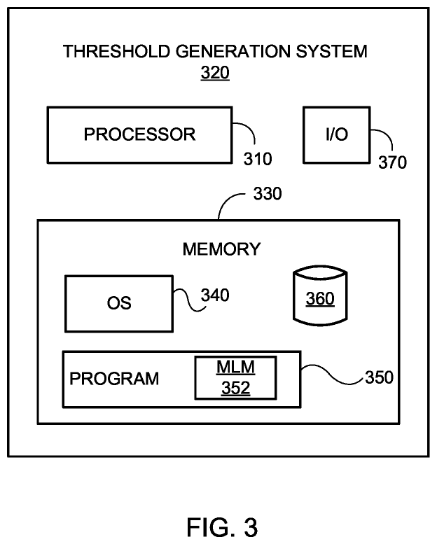

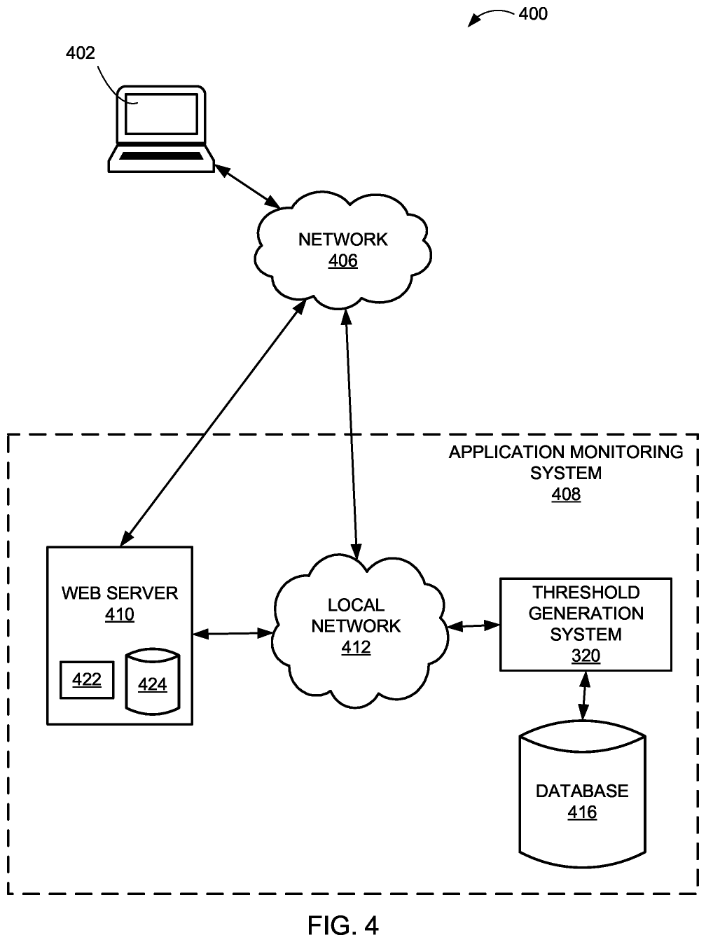

FIG. 1 is a flow diagram illustrating an exemplary method 100 for application monitoring, in accordance with certain embodiments of the disclosed technology. The steps of method 100 may be performed by one or more components of the system 400 (e.g., threshold generation system 320 or web server 410 of application monitoring system 408, or user device 402), as described in more detail with respect to FIGS. 3 and 4. While certain blocks may be identified as being optional, certain embodiments may omit blocks even if they are not necessarily identified as being optional.

In optional block 102, the threshold generation system 320 may receive first data associated with a first application. For example, the system may receive data associated with the historical operational environment, architectural patterns, design patterns, communication pathways, deployment tooling, and/or manufacturing of a first application (e.g., a load balancer, a hard drive, etc.). The data may include information pertaining to whether the first application experienced an upset, downtime, and/or a failure, e.g., based on latency, the operation of healthy versus unhealthy nodes, and the like.

In some embodiments, the system may be configured to periodically poll or monitor the first application to determine whether the system already has monitoring in place for the first application. If not, the system may check for any default policies associated with the first application such that the system may implement the default policies (e.g., frequency of monitoring). If the system determines no default policies are associated with the first application, the system may prompt a system user to provide any desired monitoring settings.

In some embodiments, prior to receiving the first data, the system may be configured to receive one or more attributes of the first application (e.g., the application type, associated metadata, etc.). Based on these attributes, the system may determine an appropriate monitor or alert to associate with the first application. This monitor or alert may provide a benefit of initially tracking operation and functionality of the first application prior to the determining and updating of monitoring thresholds, as further discussed herein.

In optional block 104, responsive to receiving the first data, the threshold generation system 320 may retrieve second data associated with the first application. In some embodiments, the second data may include, for example, user-inputted tracking or log sheets based on the operation and functionality of the first application, including user-inputted historical data, application monitoring log sheets, investigations associated with any first application failures or upsets, attempt(s) to resolve the failures or upsets, etc.

In optional block 106, the threshold generation system 320 may generate third data associated with the first application by analyzing the second data via NLP. For example, the system may be configured to scan through any log sheets or incident reports historically generated based on the operation of the first application. The system may use NLP in the scanning of this information to pull out any information or clues that may be helpful in providing more accurate threshold recommendations (further discussed below), such as information contained within incident-related data fields, any historical metrics that may be associated with anomalies of the first application, and the like.

In optional block 108, the threshold generation system 320 may train an MLM to determine a first threshold associated with the first application based on the third data. In some embodiments, the system may use the data obtained via NLP, as discussed above, to determine an initial threshold to apply to the first application. A threshold may include, for example, a percentage (e.g., of healthy nodes), an amount of time (e.g., prior to a timeout), a numerical value (e.g., associated with a first application failure), a threshold type, and the like. The threshold may indicate when and/or how (e.g., at what point) to transmit a monitor or alert, as discussed above, to a system user. For example, if the first application experiences a certain operating condition (e.g., increased latency) for at least a certain length of time, the monitor or alert may be transmitted to a system user to enable the system user to follow up (e.g., troubleshoot) on such operating condition.

In some embodiments, the system may utilize an MLM to determine the first threshold based solely on historical operational and/or function data associated with the first application. In some embodiments, the system may utilize an MLM in conjunction with NLP to aid in evaluating various types of data upon which to determine the first threshold. For example, an MLM may be trained to determine the first threshold based on historical data, while NLP may be utilized to aid the system in determining the first threshold based on user-inputted log or incident related data, as discussed above.

In block 110, the threshold generation system 320 may transmit the first threshold to a user. In some embodiments, upon determining the first threshold associated with the first application, the system may be configured to provide the first threshold to a common marketplace, such as an online marketplace accessible by a variety of different organizations or entities. The system may receive requests from these organizations or entities, the requests indicating the organizations' interest in obtaining the first threshold to apply to their own internal systems. Based on such requests, the system may transmit the first threshold to a particular user (e.g., of an external organization), such as by selling or leasing the first threshold to the user. A benefit of adding the first threshold to such a marketplace is that various organizations or entities may operate their own internal applications that are the same as or similar to the first application. As such, these organizations or entities (e.g., external to the threshold generation system 320) may find use in further updating and applying the first threshold to their own internal and similar applications.

In some embodiments, the system may be configured to push various types of recommendations to external organizations or entities via the application threshold marketplace. For example, the system may generate a recommendation for a user based on historical data (e.g., types of applications the system has previously monitored and for which the system has generated thresholds), and/or similar applications (e.g., the system may suggest a certain threshold to a user based on similar types of applications that user might have in its own internal system).

In block 112, responsive to transmitting the first threshold, the threshold generation system 320 may receive fourth data associated with a second application. In some embodiments, the fourth data may be the same as or similar to the first data (block 102) and/or second data (block 104). The second application may be similar to the first application (block 102), such as of a similar type. For example, both the first and second applications may be load balancers; however, given the first application is owned and/or operated by the system, and the second application is owned and/or operated by an organization or entity external to the system, the first and second applications may require their own modified thresholds to achieve optimal respective monitoring.

In block 114, the threshold generation system 320 may determine, via the MLM and based on the fourth data, an updated first threshold associated with the second application. In some embodiments, the MLM may be trained to start with the determined first threshold (block 108), and further update or customize the first threshold based on the fourth data, to generate an updated first threshold that more optimally or accurately applies to the second application.

In optional block 116, the threshold generation system 320 may transmit a notification to the user, the notification requesting the user provide the first response based on the updated first threshold. In some embodiments, the notification may include an email, SMS or MMS message, a web push-notification, a mobile push notification, a queue-based notification, in-application alert, or any other type of message designed to request the user provide feedback associated with how the updated first threshold is operating with respect to the user's second application. In some embodiments, the notification may include an interactive display (e.g., via a graphical user interface (GUI)) including one or more editable fields (e.g., click buttons, drop-down menus, etc.) configured such that the user may provide the first response.

In optional block 118, the threshold generation system 320 may determine whether it has received the first response. For example, the system may be configured to monitor in-application messages, chat functions, or editable fields to determine whether a response has been received.

In some embodiments, the system may be configured to determine whether the first response has been received according to permissions associated with the user. For example, these permissions (e.g., default, or user-selected) may indicate that the first response must be received from an “approval” individual, or device associated with the user, versus an “informed” individual or device. For example, some organizations may have employees or programmed devices specifically assigned an “approval” versus “informed” role, where the “approval” role allows those employees or devices to respond to various prompts on behalf of the organization, while the “informed” role allows employees or devices to only monitor or review information.

In optional block 120, responsive to receiving the first response, the threshold generation system 320 may maintain the updated first threshold associated with the second application. For example, the system may be configured to recognize that the first response indicates the user's satisfaction with the updated first threshold. In such a case, the system may not further customize or update the updated first threshold.

In some embodiments, in response to determining no first response has been received, the threshold generation system 320 may receive additional data associated with the second application such that the system may iteratively or continuously update or customize the first threshold until the system receives the first response from the user.

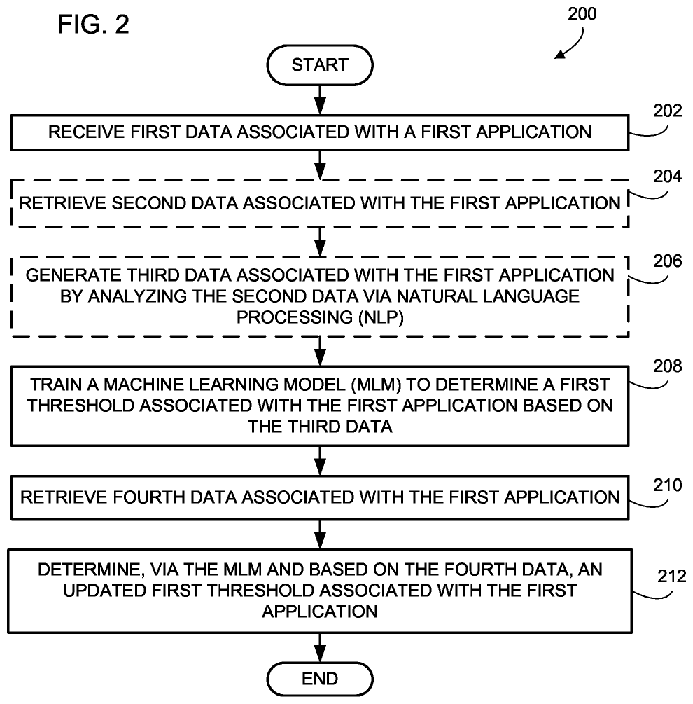

FIG. 2 is a flow diagram illustrating an exemplary method 200 for application monitoring, in accordance with certain embodiments of the disclosed technology. The steps of method 200 may be performed by one or more components of the system 400 (e.g., threshold generation system 320 or web server 410 of application monitoring system 408, or user device 402), as described in more detail with respect to FIGS. 3 and 4.

Method 200 of FIG. 2 may be the same as or similar to method 100 of FIG. 1, except that method 200 may provide a method by which a system generates and updates or customizes an initial application threshold prior to transmitting the initial threshold to an end-user. The respective descriptions of blocks 202, 204, 206, 208 of method 200 may be the same as or similar to the respective descriptions of blocks 102, 104, 106, and 108 of method 100, and as such, are not repeated herein for brevity.

In block 210, the threshold generation system 320 may retrieve fourth data associated with the first application. For example, after determining a first threshold associated with the first application (block 208), the system may be configured to receive additional data to aid in further updating or customizing the first threshold with respect to the first application.

In block 212, the threshold generation system 320 may determine, via the MLM and based on the fourth data, an updated first threshold associated with the first application. This step may be similar to block 114 of method 100; however, rather than determining an updated threshold for an external user application, the system may be configured to update or customize the first threshold with respect to the system's own internal first application.

FIG. 3 is a block diagram of an example threshold generation system 320 used to monitor applications, according to an example implementation of the disclosed technology. According to some embodiments, the user device 402 and web server 410, as depicted in FIG. 4 and described below, may have a similar structure and components that are similar to those described with respect to threshold generation system 320 shown in FIG. 3. As shown, the threshold generation system 320 may include a processor 310, an input/output (I/O) device 370, a memory 330 containing an operating system (OS) 340 and a program 350. In some embodiments, program 350 may include an MLM 352 that may be trained, for example, to determine an initial threshold associated with a first application, and to update or customize the initial threshold to generate an updated threshold based on a second application. In certain implementations, MLM 352 may issue commands in response to processing an event, in accordance with a model that may be continuously or intermittently updated. Moreover, processor 310 may execute one or more programs (such as via a rules-based platform or the trained MLM 352), that, when executed, perform functions related to disclosed embodiments.

In certain example implementations, the threshold generation system 320 may be a single server or may be configured as a distributed computer system including multiple servers or computers that interoperate to perform one or more of the processes and functionalities associated with the disclosed embodiments. In some embodiments threshold generation system 320 may be one or more servers from a serverless or scaling server system. In some embodiments, the threshold generation system 320 may further include a peripheral interface, a transceiver, a mobile network interface in communication with the processor 310, a bus configured to facilitate communication between the various components of the trust score generation system 320, and a power source configured to power one or more components of the trust score generation system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the threshold generation system 320 may include one or more storage devices configured to store information used by the processor 310 (or other components) to perform certain functions related to the disclosed embodiments. In one example, the threshold generation system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The threshold generation system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the threshold generation system 320 may include the memory 330 that may include one or more programs 350 to perform one or more functions of the disclosed embodiments. For example, in some embodiments, the threshold generation system 320 may additionally manage dialogue and/or other interactions with the customer via a program 350.

The processor 310 may execute one or more programs 350 located remotely from the trust score generation system 320. For example, the threshold generation system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a database 360 for storing related data to enable the threshold generation system 320 to perform one or more of the processes and functionalities associated with the disclosed embodiments.

The database 360 may include stored data relating to status data (e.g., average session duration data, location data, idle time between sessions, and/or average idle time between sessions) and historical status data. According to some embodiments, the functions provided by the database 360 may also be provided by a database that is external to the threshold generation system 320, such as the database 416 as shown in FIG. 4.

The threshold generation system 320 may also be communicatively connected to one or more memory devices (e.g., databases) locally or through a network. The remote memory devices may be configured to store information and may be accessed and/or managed by the threshold generation system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The threshold generation system 320 may also include one or more I/O devices 370 that may comprise one or more interfaces for receiving signals or input from devices and providing signals or output to one or more devices that allow data to be received and/or transmitted by the threshold generation system 320. For example, the threshold generation system 320 may include interface components, which may provide interfaces to one or more input devices, such as one or more keyboards, mouse devices, touch screens, track pads, trackballs, scroll wheels, digital cameras, microphones, sensors, and the like, that enable the threshold generation system 320 to receive data from a user (such as, for example, via the user device 402).

In examples of the disclosed technology, the threshold generation system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The threshold generation system 320 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The threshold generation system 320 may be configured to adjust model parameters during training. Model parameters may include weights, coefficients, offsets, or the like. Training may be supervised or unsupervised.

The threshold generation system 320 may be configured to train machine learning models by optimizing, customizing, or updating model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The threshold generation system 320 may be configured to optimize and update statistical models using known optimization techniques.

Furthermore, the threshold generation system 320 may include programs configured to retrieve, store, and/or analyze properties of data models and datasets. For example, threshold generation system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The threshold generation system 320 may include algorithms to determine a data type, key-value pairs, row-column data structure, statistical distributions of information such as keys or values, or other property of a data schema may be configured to return a statistical profile of a dataset (e.g., using a data-profiling model). The threshold generation system 320 may be configured to implement univariate and multivariate statistical methods. The threshold generation system 320 may include a regression model, a Bayesian model, a statistical model, a linear discriminant analysis model, or other classification model configured to determine one or more descriptive metrics of a dataset. For example, threshold generation system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The threshold generation system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, threshold generation system 320 may be configured to generate a similarity metric representing a measure of similarity between data in a dataset. A similarity metric may be based on a correlation, covariance matrix, a variance, a frequency of overlapping values, or other measure of statistical similarity.

The threshold generation system 320 may be configured to generate a similarity metric based on data model output, including data model output representing a property of the data model. For example, threshold generation system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The threshold generation system 320 may be configured to classify a dataset. Classifying a dataset may include determining whether a dataset is related to another dataset. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The threshold generation system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, threshold generation system 320 is configured to generate and/or train a classification model to classify a dataset, consistent with disclosed embodiments.

The threshold generation system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via weighted connections. Prediction models may additionally or alternatively include classification and regression trees, or other types of models known to those skilled in the art. To generate prediction models, the asset detection system may analyze information applying machine-learning methods.

While the threshold generation system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the threshold generation system 320 may include a greater or lesser number of components than those illustrated.

FIG. 4 is a block diagram of an example system that may be used to view and interact with application monitoring system 408, according to an example implementation of the disclosed technology. The components and arrangements shown in FIG. 4 are not intended to limit the disclosed embodiments as the components used to implement the disclosed processes and features may vary. As shown, application monitoring system 408 may interact with a user device 402 via a network 406. In certain example implementations, the application monitoring system 408 may include a local network 412, a threshold generation system 320, a web server 410, and a database 416.

In some embodiments, a respective user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the application monitoring system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the application monitoring system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The threshold generation system 320 may include programs (scripts, functions, algorithms) to configure data for visualizations and provide visualizations of datasets and data models on the user device 402. This may include programs to generate graphs and display graphs. The threshold generation system 320 may include programs to generate histograms, scatter plots, time series, or the like on the user device 402. The threshold generation system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as RFID, NFC, Bluetooth™, BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The application monitoring system 408 may be associated with and optionally controlled by one or more entities such as a business, corporation, individual, partnership, or any other entity that provides one or more of goods, services, and consultations to individuals such as customers. In some embodiments, the application monitoring system 408 may be controlled by a third party on behalf of another business, corporation, individual, partnership. The application monitoring system 408 may include one or more servers and computer systems for performing one or more functions associated with products and/or services that the organization provides.

Web server 410 may include a computer system configured to generate and provide one or more websites accessible to customers, as well as any other individuals involved in accessing application monitoring system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the threshold generation system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the application monitoring system 408 to interact with one another and to connect to the network 406 for interacting with components in the system 400 environment. In some embodiments, the local network 412 may include an interface for communicating with or linking to the network 406. In other embodiments, certain components of the application monitoring system 408 may communicate via the network 406, without a separate local network 406.

The application monitoring system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access application monitoring system 408 using the cloud computing environment. User device 402 may be able to access application monitoring system 408 using specialized software. The cloud computing environment may eliminate the need to install specialized software on user device 402.

In accordance with certain example implementations of the disclosed technology, the application monitoring system 408 may include one or more computer systems configured to compile data from a plurality of sources, such as the threshold generation system 320, web server 410, and/or the database 416. The threshold generation system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes examples of a typical user flow pattern. This section is intended solely for explanatory purposes and not in limitation.

In one example, a system may be configured to monitor the operation of an application, such as a load balancer, associated with a first organization. In monitoring the load balancer's operation, the system may receive data associated with latency, downtime, upsets, failures, node functionality, etc., associated with the load balancer. The system may first determine a monitor or alert to associate with the load balancer based on the load balancer's inherent attributes (e.g., its type and metadata). This monitor or alert may be transmitted to various system users, for example, when the load balancer operates in different ways. For example, a monitor or alert for the load balancer may be based on node health state.

The system may be further configured to retrieve any incident reports or log sheets that were entered over a previous period of time (e.g., the past two years) associated with the operation of the load balancer. Using NLP, the system may scan the incident reports and log sheets to extract any information associated with failures or upsets of the load balancer (e.g., times, dates, reasons for failure, how the failure was fixed, etc.). Using NLP in this way may enable the system to determine a monitoring threshold at which to transmit the initially determined monitor or alert. For example, the first threshold may correspond to a percentage of healthy nodes (e.g., 92%) that should be present for acceptable operation of the load balancer, and/or that below which may prompt a notification be sent to a system operator.

The system may be further configured to train an MLM to determine a first threshold for the load balancer based on historical data associated with the load balancer. The MLM may operate independently or in conjunction with NLP, as discussed above.

Once the system determines the first threshold associated with the first application, the system may place the first threshold in a marketplace accessible by a variety of external organizations or entities. An organization may own and/or operate its own load balancers within its internal system infrastructure, and thus may have interest in obtaining the first threshold to apply to its own load balancer(s). The organization may express interest in obtaining the first threshold, and the system may transmit (e.g., sell and/or transmit via the cloud) the first threshold to the organization. The organization may then periodically provide the system with data associated with its own internal load balancer(s) such that the system can customize or update the first threshold so that it more accurately monitors and associates with the organization's load balancer(s).

In some embodiments, the system may be configured to iteratively customize or update the first threshold based on new data provided by the organization until the system receives a response from the organization that it is satisfied with the updated first threshold. At that point, the system may cease its updating or customizing of the first threshold such that the organization may continue to use the latest version (e.g., most recently updated) of the first application in monitoring its own load balancer(s).

In some examples, disclosed systems or methods may involve one or more of the following clauses:
Clause 1: A system comprising: one or more processors; and a memory in communication with the one or more processors and storing instructions that, when executed by the one or more processors, are configured to cause the system to: receive first data associated with a first application; responsive to receiving the first data, retrieve second data associated with the first application; generate third data associated with the first application by analyzing the second data via natural language processing (NLP); train a machine learning model (MLM) to determine a first threshold associated with the first application based on the third data; transmit the first threshold to a user; responsive to transmitting the first threshold, receive fourth data associated with a second application; and determine, via the MLM and based on the fourth data, an updated first threshold associated with the second application.
Clause 2: The system of clause 1, wherein the first data corresponds to a failure of the first application.
Clause 3: The system of clause 2, wherein the second data corresponds to one or more investigations associated with the failure, one or more attempts to resolve the failure, or both.
Clause 4: The system of clause 2, wherein the first threshold comprises a numerical value associated with resolving the failure.
Clause 5: The system of clause 1, wherein the first threshold comprises a threshold type and a threshold numerical value.
Clause 6: The system of clause 1, wherein the fourth data comprises historical operational data.
Clause 7: The system of clause 1, wherein the instructions are further configured to cause the system to: receive a request from the user, wherein transmitting the first threshold to the user is responsive to receiving the request.
Clause 8: The system of clause 1, wherein the instructions are further configured to cause the system to: receive one or more attributes associated with the first application; and determine a first alert associated with the first application, the first alert based on the one or more attributes, wherein the first threshold corresponds to the first alert.
Clause 9: A system comprising: one or more processors; and a memory in communication with the one or more processors and storing instructions that, when executed by the one or more processors, are configured to cause the system to: transmit a first threshold to a user, the first threshold associated with a first application; iteratively until a first response is received: receive data associated with a second application; determine, via a machine learning model (MLM) and based on the data, an updated first threshold associated with the second application; and transmit a notification to the user, the notification requesting the user provide the first response based on the updated first threshold; and maintain the updated first threshold associated with the second application.
Clause 10: The system of clause 9, wherein the instructions are further configured to cause the system to: receive first data associated with the first application; responsive to receiving the first data, retrieve second data associated with the first application; generate third data associated with the first application by analyzing the second data via natural language processing (NLP); and train the MLM to determine the first threshold associated with the first application based on the third data.
Clause 11: The system of clause 10, wherein: the first data corresponds to a failure of the first application; and the second data corresponds to one or more investigations associated with the failure, one or more attempts to resolve the failure, or both.
Clause 12: The system of clause 9, wherein the first threshold comprises a threshold type and a threshold numerical value.
Clause 13: The system of clause 9, wherein the notification comprises one or more of an email, a SMS message, an MMS message, a web push notification, a mobile push notification, a queue-based notification, or combinations thereof.
Clause 14: The system of clause 9, wherein the instructions are further configured to cause the system to: receive a request from the user, wherein transmitting the first threshold to the user is responsive to receiving the request.
Clause 15: The system of clause 9, wherein the first and second applications are of a similar type of application.
Clause 16: A system comprising: one or more processors; and a memory in communication with the one or more processors and storing instructions that, when executed by the one or more processors, are configured to cause the system to: receive first data associated with a first application, the first data corresponding to a failure of the first application; train a machine learning model (MLM) to determine a first threshold associated with the first application based on the first data; retrieve second data associated with the first application, the second data corresponding to a time period prior to a start time of the failure; and determine, via the MLM and based on the second data, an updated first threshold associated with the first application.
Clause 17: The system of clause 16, wherein the instructions are further configured to cause the system to: transmit the updated first threshold to a user; responsive to transmitting the updated first threshold, receive third data associated with a second application; and determine, via the MLM and based on the third data, a second threshold associated with the second application.
Clause 18: The system of clause 16, wherein the instructions are further configured to cause the system to: responsive to receiving the first data, retrieve third data associated with the first application; and generate fourth data associated with the first application by analyzing the third data via natural language processing (NLP), wherein determining the first threshold is further based on the fourth data.
Clause 19: The system of claim 18, wherein the third data corresponds to one or more investigations associated with the failure, one or more attempts to resolve the failure, or both.
Clause 20: The system of clause 16, wherein the instructions are further configured to cause the system to: transmit the updated first threshold to a user; iteratively until a first response is received: receive third data associated with a second application; determine, via the MLM and based on the third data, a second threshold associated with the second application; and transmit a notification to the user, the notification requesting the user provide the first response based on the second threshold; and maintain the second threshold associated with the second application.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive first data associated with a first application;
responsive to receiving the first data, retrieve second data associated with the first application;
generate third data associated with the first application by analyzing the second data via natural language processing (NLP);
train a machine learning model (MLM) to determine a first threshold associated with the first application based on the third data;
transmit the first threshold to a user;
responsive to transmitting the first threshold, receive fourth data associated with a second application; and
determine, via the MLM and based on the fourth data, an updated first threshold associated with the second application.

2. The system of claim 1, wherein the first data corresponds to a failure of the first application.

3. The system of claim 2, wherein the second data corresponds to one or more investigations associated with the failure, one or more attempts to resolve the failure, or both.

4. The system of claim 2, wherein the first threshold comprises a numerical value associated with resolving the failure.

5. The system of claim 1, wherein the first threshold comprises a threshold type and a threshold numerical value.

6. The system of claim 1, wherein the fourth data comprises historical operational data.

7. The system of claim 1, wherein the instructions are further configured to cause the system to:
receive a request from the user,
wherein transmitting the first threshold to the user is responsive to receiving the request.

8. The system of claim 1, wherein the instructions are further configured to cause the system to:
receive one or more attributes associated with the first application; and
determine a first alert associated with the first application, the first alert based on the one or more attributes,
wherein the first threshold corresponds to the first alert.

9. A system comprising:
one or more processors; and
a memory in communication with the one or more processors and storing instructions that, when executed by the one or more processors, are configured to cause the system to:
transmit a first threshold to a user, the first threshold associated with a first application;
iteratively until a first response is received:
receive data associated with a second application;
determine, via a machine learning model (MLM) and based on the data, an updated first threshold associated with the second application; and
transmit a notification to the user, the notification requesting the user provide the first response based on the updated first threshold; and
maintain the updated first threshold associated with the second application.

10. The system of claim 9, wherein the instructions are further configured to cause the system to:
receive first data associated with the first application;
responsive to receiving the first data, retrieve second data associated with the first application;
generate third data associated with the first application by analyzing the second data via natural language processing (NLP); and
train the MLM to determine the first threshold associated with the first application based on the third data.

11. The system of claim 10, wherein:
the first data corresponds to a failure of the first application; and
the second data corresponds to one or more investigations associated with the failure, one or more attempts to resolve the failure, or both.

12. The system of claim 9, wherein the first threshold comprises a threshold type and a threshold numerical value.

13. The system of claim 9, wherein the notification comprises one or more of an email, a SMS message, an MMS message, a web push notification, a mobile push notification, a queue-based notification, or combinations thereof.

14. The system of claim 9, wherein the instructions are further configured to cause the system to:
receive a request from the user,
wherein transmitting the first threshold to the user is responsive to receiving the request.

15. The system of claim 9, wherein the first and second applications are of a similar type of application.

16. A system comprising:
one or more processors; and
a memory in communication with the one or more processors and storing instructions that, when executed by the one or more processors, are configured to cause the system to:
receive first data associated with a first application, the first data corresponding to a failure of the first application;
train a machine learning model (MLM) to determine a first threshold associated with the first application based on the first data;
retrieve second data associated with the first application, the second data corresponding to a time period prior to a start time of the failure; and
determine, via the MLM and based on the second data, an updated first threshold associated with the first application.

17. The system of claim 16, wherein the instructions are further configured to cause the system to:
transmit the updated first threshold to a user;
responsive to transmitting the updated first threshold, receive third data associated with a second application; and
determine, via the MLM and based on the third data, a second threshold associated with the second application.

18. The system of claim 16, wherein the instructions are further configured to cause the system to:
responsive to receiving the first data, retrieve third data associated with the first application; and
generate fourth data associated with the first application by analyzing the third data via natural language processing (NLP),
wherein determining the first threshold is further based on the fourth data.

19. The system of claim 18, wherein the third data corresponds to one or more investigations associated with the failure, one or more attempts to resolve the failure, or both.

20. The system of claim 16, wherein the instructions are further configured to cause the system to:
transmit the updated first threshold to a user;
iteratively until a first response is received:
receive third data associated with a second application;
determine, via the MLM and based on the third data, a second threshold associated with the second application; and
transmit a notification to the user, the notification requesting the user provide the first response based on the second threshold; and
maintain the second threshold associated with the second application.
